(19) United States
(12) Patent Application Publication
(10) Pub. No.: US 2025/0083780 A1
(43) Pub. Date: Mar. 13, 2025

(54) APPARATUS AND METHOD FOR CONTROLLING POSITION OF MOBILE OBJECT INCLUDING LOW VISIBILITY VIDEO IMPROVEMENT APPARATUS

(71) Applicant: LTechkorea, Inc., Seoul (KR)

(72) Inventor: IKJIN JANG, Hwaseong-si (KR)

(21) Appl. No.: 18/583,479

(22) Filed: Feb. 21, 2024

(30) Foreign Application Priority Data
Sep. 4, 2023 (KR) 10-2023-0116650

(51) Int. Cl. B63B 49/00; B63B 79/10; B63B 79/40; G06T 5/70; G06T 7/00; G06T 7/11

(52) U.S. Cl. CPC B63B 49/00; B63B 79/10; B63B 79/40; G06T 5/70; G06T 7/0002; G06T 7/11; G06T 2207/10016; G06T 2207/20021; G06T 2207/30168; G06T 2207/30232; G06T 2207/30252

(57) ABSTRACT

The present specification discloses an apparatus and method for controlling a position of a mobile object including a low visibility video improvement apparatus. The apparatus may include: a video input unit that receives a captured video from capturing equipment; a video correction unit that receives the captured video from the video input unit to calculate a transmission rate, and uses the transmission rate to correct the captured video; a low visibility determination unit that receives the transmission rate from the video correction unit, determines whether a mobile object is present in a low visibility section using a lower limit of the transmission rate, and outputs a result value; and a position control unit.

### CROSS-REFERENCE TO RELATED APPLICATION

This application claims priority to and the benefit of Korean Patent Application No. 10-2023-0116650, filed on Sep. 4, 2023, the disclosure of which is incorporated herein by reference in its entirety.

### BACKGROUND

### 1. Field of the Invention

The present invention relates to an apparatus and method for controlling a position of a mobile object, and more particularly, to an apparatus and method for controlling a mobile object to be positioned in a low visibility section.

### 2. Discussion of Related Art

The contents described in this section merely provide background information for an embodiment described in the present specification and do not necessarily constitute the related art.

Recently, video processing and monitoring technologies capable of clearly identifying monitoring targets even in low visibility weather conditions have been developed. These video processing and monitoring technologies are very useful in the defense field, and the introduction of monitoring systems with low visibility video processing technologies applied to unmanned mobile objects being developed in the defense field is actively underway.

However, even if the unmanned mobile objects to which the low visibility video improvement technologies are applied operate and monitor opposing camps, even the opposing camps may easily identify the mobile objects using the monitoring devices to which similar technologies are applied, so there is a limitation that the expensive unmanned mobile objects may be lost due to an opponent's neutralization response.

### RELATED ART DOCUMENT

### Patent Document

(Patent Document 1) Korean Patent No. 10-2346752 (Dec. 29, 2021)

### SUMMARY OF THE INVENTION

The present invention is directed to providing a position control apparatus and method for controlling a mobile object to maintain a low visibility section.

The present specification is not limited to the above-described problems, and other problems that are not described may be obviously understood by those skilled in the art from the following description.

According to an aspect of the present invention, there is provided an apparatus for controlling a position of a mobile object, including: a video input unit that receives a captured video from capturing equipment; a video correction unit that receives the captured video from the video input unit to calculate a transmission rate, and uses the transmission rate to correct the captured video; a low visibility determination unit that receives the transmission rate from the video correction unit, determines whether a mobile object is present in a low visibility section using a lower limit of the transmission rate, and outputs a result value; and a position control unit that controls a position of the mobile object so that the mobile object is present in the low visibility section when a result value of determining that the mobile object is not positioned in the low visibility section is input from the low visibility determination unit.

The video correction unit may calculate an estimate [symbol] of the transmission rate by Expression

$$t ( x ) = 1 - \frac{α J ( x )}{A} , 0 < α < 1$$

using a pixel value I(x) of the captured video and atmospheric brightness A in the captured video, the transmission rate t(x) may have a range of

$$1 - \frac{J ( x )}{A} \leq t ( x ) \leq 1 ,$$

a lower limit

$$1 - \frac{J ( x )}{A}$$

of the transmission rate t(x) and the estimate [symbol] of the transmission rate may be a weighted sum to calculate the transmission rate t(x) by Expression

$$= + ( 1 - ω ) ( 1 - \frac{J ( x )}{A} ) , 0 < ω < 1$$

and a pixel value J(x) of the video corrected using the transmission rate t(x) calculated by the weighted sum is calculated by Expression

$$J ( x ) = \frac{I ( x ) - A}{t ( x )} + A$$

The low visibility determination unit may determine that the mobile object is positioned in the low visibility section when the lower limit of the transmission rate is present within a predetermined transmission rate critical range.

The video correction unit may divide the captured video into at least one block area, select the at least one block area from divided videos, calculate the transmission rate from the selected area, and output the calculated transmission rate to the low visibility determination unit.

The apparatus may further include a video comparison unit that receives the captured video from the video input unit and receives the corrected video from the video correction unit to divide the two videos into at least one block area, selects the at least one block area from the two divided videos, and calculates a brightness comparison value, which accumulates a difference in brightness between the two videos, by Expression

$$Result = {\sum }_{k = 1}^{n} \vert {A}_{k} - {B}_{k} \vert$$

(n: natural number, Aₖ: k^{th} area or pixel of the captured video, Bₖ: k^{th} area or pixel of the corrected video), and outputs the comparison value to the low visibility determination unit.

The low visibility determination unit may determine that the mobile object is present in the low visibility section when the comparison value received from the video comparison unit is present within a predetermined comparison value critical range.

According to another aspect of the present invention, there is provided a method of controlling a position of a mobile object, including: operation (a) of receiving, by a processor, a captured video from capturing equipment; operation (b) of calculating, by the processor, a transmission rate of the captured video; operation (c) of determining, by the processor, whether the mobile object is present in a low visibility section using a lower limit of the transmission rate calculated in operation (b); and operation (d) of, when it is determined that the mobile object is not positioned in the low visibility section, controlling, by the processor, the position of the mobile object so that the mobile object is present in the low visibility section.

In operation (b), the processor may calculate a range of the transmission rate t(x) by Expression

$$1 - \frac{J ( x )}{A} \leq t ( x ) \leq 1$$

using a pixel value I(x) of the captured video and atmospheric brightness A in the captured video.

In operation (c), it may be determined that the mobile object is positioned in the low visibility section when the lower limit of the transmission rate is present within a predetermined transmission rate critical range.

In operation (b), the processor may divide the captured video into at least one block area, select the at least one block area from divided videos, and calculate the transmission rate.

According to still another aspect of the present invention, there is provided a method of controlling a position of a mobile object, including: operation (a) of receiving, by a processor, a captured video from capturing equipment; operation (b) of calculating, by the processor, a transmission rate of the captured video; operation (c′−1) of correcting, by the processor, the captured video using the transmission rate calculated in operation (b); operation (c′−2) of calculating, by the processor, a comparison value of brightness between the captured video and the video corrected in operation (c′−1); operation (c′−3) of determining, by the processor, whether a mobile object is present in a low visibility section using the comparison value calculated in operation (c′−2); and operation (d) of, when it is determined that the mobile object is not positioned in the low visibility section, controlling, by the processor, a position of the mobile object so that the mobile object is present in the low visibility section.

In operation (c′−1), the processor may calculate an estimate [symbol] of the transmission rate by Expression

$$= 1 - \frac{α J ( x )}{A} , 0 < α < 1$$

using a pixel value I(x) of the captured video and atmospheric brightness A in the captured video, the transmission rate t(x) may have a range of

$$1 - \frac{J ( x )}{A} \leq t ( x ) \leq 1 ,$$

and a lower limit

$$1 - \frac{J ( x )}{A}$$

of the transmission rate t(x) and the estimate [symbol] of the transmission rate may be weight-summed to calculate the transmission rate t(x) by Expression

$$t ( x ) = + ( 1 - ω ) ( 1 - \frac{J ( x )}{A} ) , 0 < ω < 1 \text{?} ,$$

$$\text{?} \text{indicates text missing or illegible when filed}$$

and a pixel value J(x) of the video corrected using the transmission rate t(x) calculated by the weighted sum is calculated by Expression

$$J ( x ) = \frac{I ( x ) - A}{A} + A .$$

In operation (c′−2), the processor may divide the captured video and the corrected video into at least one block area, select at least one block area from the two divided videos, and calculate a brightness comparison value, which accumulates a difference in brightness between the two videos, by Expression

$$Result = {\sum }_{k = 1}^{N} \vert {A}_{k} - {B}_{k} \vert$$

(n: natural number, Aₖ: k^{th} area or pixel of the captured video, Bₖ: k^{th} area or pixel of the corrected video).

In operation (c′−3), the processor may determine that the mobile object is present in the low visibility section when the comparison value calculated in operation (c′−2) is present within a predetermined comparison value critical range.

The method may further include: when it is determined in operation (c) that the mobile object moves forward, after operation (c), operation (c′−1) of correcting, by the processor, the captured video using the transmission rate calculated in operation (b); operation (c′−2) of calculating, by the processor, a comparison value of brightness between the captured video and the video corrected in operation (c′−1); and operation (c′−3) of determining, by the processor, whether the mobile object is present in a low visibility section using the comparison value calculated in operation (c′−2).

The method of controlling a position of a mobile object according to the present specification may be implemented in the form of a computer program that is written to allow a computer to perform each operation and recorded on a computer-readable recording medium.

Other specific details of the invention are included in the detailed description and drawings.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a schematic diagram illustrating position movement of a mobile object using an apparatus for controlling a position of a mobile object according to the present specification;

FIG. 2 is a schematic configuration diagram of a system for controlling a position of a mobile object according to an embodiment of the present specification;

FIGS. 3A to 3D are comparison diagrams of a captured video and a video corrected by a video correction unit;

FIGS. 4A and 4B are diagrams illustrating that the video correction unit divides the captured video into block areas and then corrects the captured video;

FIG. 5 is an algorithm for selecting some areas of divided videos;

FIG. 6 is a block diagram of an apparatus for controlling a position of a mobile object according to another embodiment of the present specification;

FIGS. 7A to 7D are diagrams illustrating that a video comparison unit compares the captured video and the corrected video;

FIG. 8 is a schematic flowchart of a method of controlling a position of a mobile object according to the present specification;

FIG. 9 is a flowchart of the method of controlling a position of a mobile object according to the embodiment of the present specification;

FIG. 10 is a flowchart of a method of controlling a position of a mobile object according to another embodiment of the present specification;

FIG. 11 is a flowchart of a method of controlling a position of a mobile object according to still another embodiment of the present specification;

FIG. 12 is a flowchart of a method of controlling a position of a mobile object according to yet another embodiment of the present specification;

FIG. 13 is a flowchart of a method of controlling a position of a mobile object according to yet another embodiment of the present specification; and

FIG. 14 is a flowchart of a method of controlling a position of a mobile object according to yet another embodiment of the present specification.

### DETAILED DESCRIPTION OF EXEMPLARY EMBODIMENTS

Various advantages and features of the present invention disclosed in the present specification and methods accomplishing them will become apparent from the following description of embodiments with reference to the accompanying drawings. However, the present specification is not limited to embodiments to be described below, but may be implemented in various different forms, these embodiments will be provided only in order to make the disclosure of the present specification complete and allow those skilled in the art (hereinafter referred to as ‘those skilled in the art’) to which the present specification pertains to completely recognize the scope of the present specification, and the scope of rights in the present specification is only defined by the scope of the claims.

Terms used in the present specification are for describing embodiments rather than limiting the scope of rights of the present specification. Unless otherwise stated, a singular form includes a plural form in the present specification. Throughout the present specification, the term “comprises” and/or “comprising” will be understood to imply the inclusion of stated constituents but not the exclusion of any other constituents.

Like reference numerals refer to like components throughout the specification and “and/or” includes each of the components mentioned and includes all combinations thereof. Although the terms “first,” “second,” and the like are used to describe various components, it goes without saying that these components are not limited by these terms. These terms are used only to distinguish one component from other components. Therefore, it goes without saying that the first component mentioned below may be the second component in the technical scope of the present invention.

Unless defined otherwise, all terms (including technical and scientific terms) used in the present specification have the same meanings commonly understood by those skilled in the art to which the present specification pertains. In addition, terms defined in commonly used dictionary are not ideally or excessively interpreted unless explicitly defined otherwise.

Hereinafter, embodiments of the present invention will be described in detail with reference to the accompanying drawings.

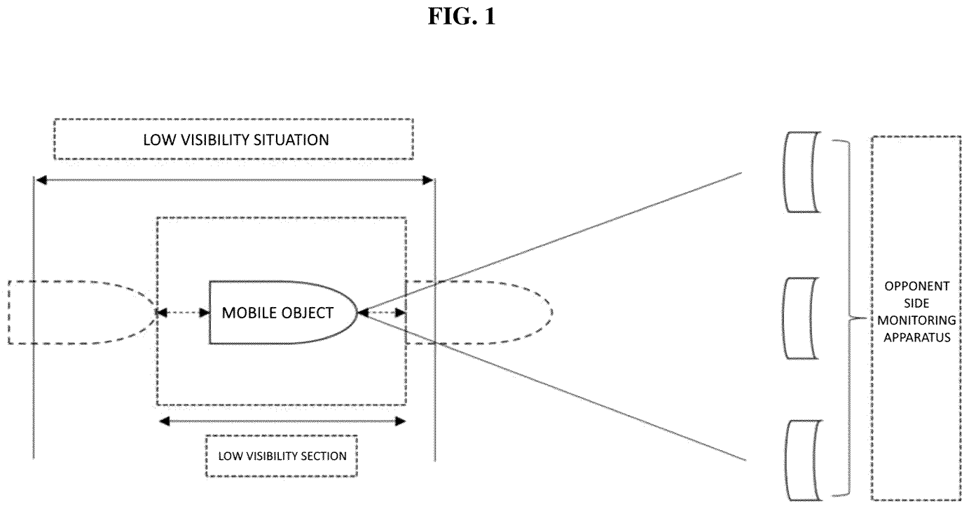

FIG. 1 is a schematic diagram illustrating position movement of a mobile object using an apparatus for controlling a position of a mobile object according to the present specification.

Referring to FIG. 1, the apparatus for controlling a position of a mobile object according to the present specification assumes a situation where the mobile object monitors an enemy in a low visibility section. In the present specification, the low visibility section is a section in which the enemy may be monitored in the low visibility situation but which is not discovered by the enemy. The low visibility situation is a situation in which a field of view of capturing equipment included in the mobile object is limited and may be caused by fog, fine dust, rain, snow, and/or smog, etc., and is not limited by specific situations. The apparatus for controlling a position of a mobile object may control the position of the mobile object so that the mobile object is positioned within the low visibility section. In the present specification, it is assumed that a direction (direction in which an enemy is positioned) facing an opponent side monitoring device is a forward direction of the mobile object.

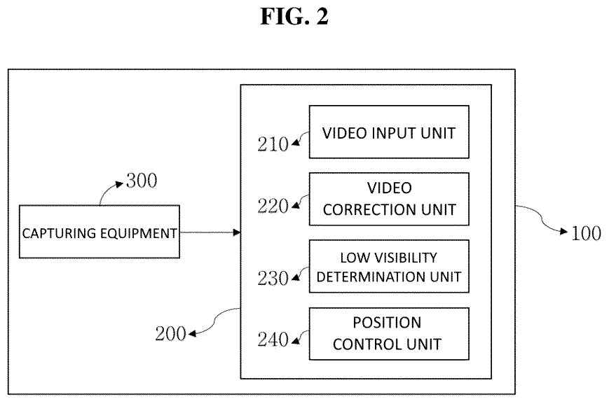

FIG. 2 is a schematic configuration diagram of a system for controlling a position of a mobile object according to an embodiment of the present specification.

Referring to FIG. 2, a mobile object 100 may include an apparatus 200 for controlling a position of a mobile object and capturing equipment 300.

The apparatus 200 for controlling a position of a mobile object may receive a captured video from the capturing equipment 300. The apparatus 200 for controlling a position of a mobile object may determine whether the mobile object 100 is positioned in the low visibility section based on the captured video and determine whether the mobile object 100 is positioned in the low visibility section to control the position of the mobile object 100 so that the mobile object 100 may be present in the low visibility section.

The video captured by the capturing equipment 300 may be a captured video in a low visibility situation and/or a captured video in a situation other than the low visibility situation.

The apparatus 200 for controlling a position of a mobile object may include a video input unit 210, a video correction unit 220, a low visibility determination unit 230, and a position control unit 240.

The video input unit 210 may receive the captured video from the capturing equipment 300.

The video correction unit 220 may receive the captured video from the video input unit 210. The video correction unit 220 may calculate a transmission rate from the captured video and correct the captured video using the transmission rate.

The low visibility determination unit 230 may receive the transmission rate from the video correction unit 220. The low visibility determination unit 230 may determine whether the mobile object 100 is present in the low visibility section using a lower limit of the transmission rate among the transmission rate values and output a result value.

When a result value of determining that the mobile object 100 is not positioned in the low visibility section is input from the low visibility determination unit 230, the position control unit 240 may control the position of the mobile object so that the mobile object 100 is positioned in the low visibility section.

The video correction unit 220 may use [Expression 1] used in general fog removal modeling to correct the low visibility in the captured video.

$$I ( x ) = J ( x ) t ( x ) + A ( 1 - t ( x ) ) \qquad [ Expression 1 ]$$

In the above [Expression 1], I(x) denotes an x^{th} pixel value of the captured video, J(x) denotes an x^{th} pixel value of the video corrected in the video correction unit 220, and A denotes atmospheric brightness furthest from the capturing equipment 300 among the pixels in the captured video and denotes brightness of a material that constitutes the fog and/or low visibility situation. t(x) denotes a transmission rate, which means a ratio of the I(x) and J(x), and the higher the transmission rate, the more similar the captured video and the corrected video are. The transmission rate t(x) decreases exponentially according to a distance of a subject of the captured video from the capturing equipment 300, as shown in [Expression 2].

$$t ( x ) = {e}^{- β d ( x )} \qquad [ Expression 2 ]$$

In the above [Expression 2], β denotes a scattering coefficient of air, and d(x) denotes a distance between a spatial point corresponding to the x^{th} pixel and the capturing equipment 300.

The video correction unit 220 may calculate the A and t(x) from the captured video and calculate the pixel value J(x) of the corrected video using the calculated A and t(x).

From the above [Expression 1], the transmission rate t(x) and the pixel value J(x) of the corrected video may be calculated by [Expression 3] and [Expression 4], respectively.

$$t ( x ) = \frac{I ( x ) - A}{J ( x ) - A} \qquad [ Expression 3 ]$$

$$J ( x ) = \frac{I ( x ) - A}{t ( x )} + A \qquad [ Expression 4 ]$$

In order to calculate the transmission rate t(x) from the captured video, the video correction unit 220 may calculate the estimate [symbol] of the transmission rate by [Expression 5].

$$= 1 - \frac{α J ( x )}{A} , 0 < α < 1 \qquad [ Expression 5 ]$$

In the above [Expression 5], the larger the input parameter α, the higher the low visibility improvement intensity.

In addition, the pixel value J(x) of the corrected video should satisfy 0≤J(x)≤I(x), so the range of the transmission rate t(x) from the above [Expression 4] may be expressed by [Expression 6].

$$1 - \frac{J ( x )}{A} \leq t ( x ) \leq 1 \qquad [ Expression 6 ]$$

Finally, the transmission rate t(x) may be calculated as a weighted sum of the [symbol] as in [Expression 7] and a lower limit

$$1 - \frac{J ( x )}{A}$$

of the transmission rate as in the above [Expression 6].

$$t ( x ) = + ( 1 - ω ) ( 1 - \frac{J ( x )}{A} ) , 0 < ω < 1 \qquad [ Expression 7 ]$$

In the above [Expression 7], ω denotes a weight, and calculating the transmission rate t(x) using the weighted sum of the estimate [symbol] of the transmission rate and the lower limit

$$1 - \frac{J ( x )}{A}$$

of the transmission rate is widely known to those skilled in the art, and therefore, detailed description thereof will be omitted.

The video correction unit 220 may substitute the transmission rate t(x) calculated using the [Expression 7] into the above [Expression 4] to calculate the pixel value J(x) of the corrected video and output the corrected video.

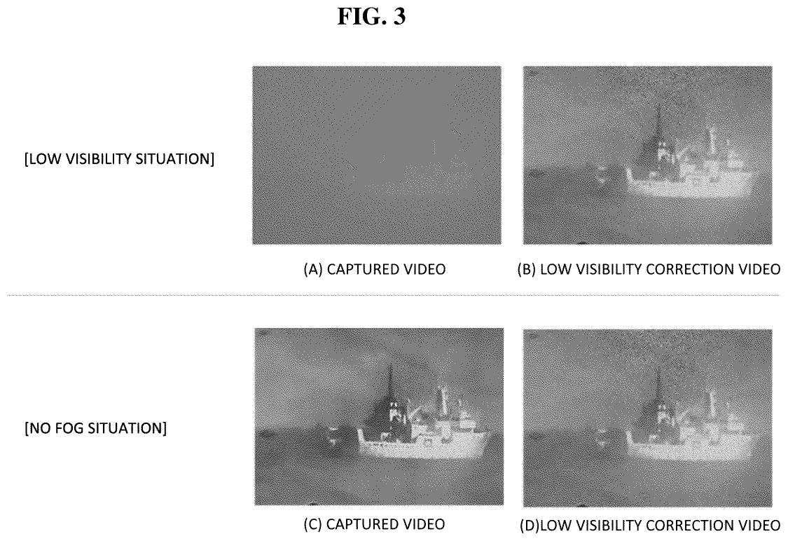

FIGS. 3A to 3D are comparison diagrams of the captured video and the video corrected by the video correction unit.

Referring to FIGS. 3A to 3D, FIG. 3A illustrates the captured video in the low visibility situation. In FIG. 3A, a subject is dark due to the low visibility situation. The video correction unit 220 may calculate the transmission rate using the above [Expression 7] from the captured video in the low visibility situation and output the corrected video. FIG. 3B is a video that has been corrected from the video illustrated in FIG. 3A, and the low visibility situation is improved, and thus, the subject appears more clearly than FIG. 3A.

FIG. 3C is the captured video in the situations other than the low visibility situation. FIG. 3D is a video in which the video correction unit 220 calculates the transmission rate using [Expression 7] and corrects the video in FIG. 3C. FIG. 3C illustrates the captured video in the situation other than the low visibility situation, and therefore, the subject in FIG. 3C and the subject in FIG. 3D may have similar brightness.

The low visibility determination unit 230 may receive the transmission rate calculated by the video correction unit 220 to determine whether the mobile object 100 is positioned in the low visibility section.

The transmission rate has a range of [Expression 6], and the low visibility determination unit 230 may determine whether the mobile object 100 is positioned in the low visibility section using the lower limit

$$1 - \frac{J ( x )}{A}$$

of the transmission rate.

For example, in a foggy situation, water vapor in the atmosphere scatters light to reduce brightness of a video. In this case, when a distance is long like pixels in a background behind the fog, the transmission rate will have a value close to “0,” and nearby pixels will have a transmission rate close to “1.” Therefore, when a lower limit of the transmission rate is close to “1,” the situation may be determined to not be the low visibility situation, and when the lower limit of the transmission rate is close to “0,” the situation may be determined to be the low visibility situation.

The low visibility determination unit 230 may determine that the mobile object 100 is positioned in the low visibility section when the lower limit of the transmission rate is present within a predetermined transmission rate critical range.

When the lower limit of the transmission rate calculated from the captured video is close to “0,” there may be a situation in which the mobile object 100 leaves from the low visibility section in a direction away from an enemy and cannot monitor the enemy. Conversely, when the lower limit of the transmission rate is close to “1,” there may be a situation in which the mobile object 100 leaves from the low visibility section in a direction approaching the enemy and can be discovered by the enemy.

Accordingly, the low visibility determination unit 230 may set the transmission rate critical range for determining the low visibility section so that the mobile object 100 may monitor the enemy in the low visibility situation but may be present at a position where the mobile object 100 is not discovered by the enemy. As an example, the transmission rate critical range may be calculated as in [Expression 8].

$$Transmission rate critical range = ω + , 0 < ω < 1 \qquad [ Expression 8 ]$$

In the above [Expression 8], ω means a weight.

The low visibility determination unit 230 may determine that the mobile object 100 is positioned in the low visibility section when the lower limit of the transmission rate is present within the predetermined transmission rate critical range.

For example, the mobile object 100 may be positioned in a place where the lower limit of the transmission rate has a smaller value than the lower limit of the transmission rate critical range. In this case, the mobile object 100 may leave from the low visibility section in the direction away from the enemy, and thus, may not monitor the enemy. In this case, the position control unit 240 may move the mobile object 100 forward so that the mobile object 100 is positioned in the low visibility section.

Conversely, the mobile object 100 may be positioned in a place where the lower limit of the transmission rate has a greater value than the upper limit of the transmission rate critical range. In this case, the mobile object 100 may leave from the low visibility section in the direction approaching the enemy, and thus, may be discovered by the enemy. In this case, the position control unit 240 may move the mobile object 100 rearward so that the mobile object 100 is positioned in the low visibility section.

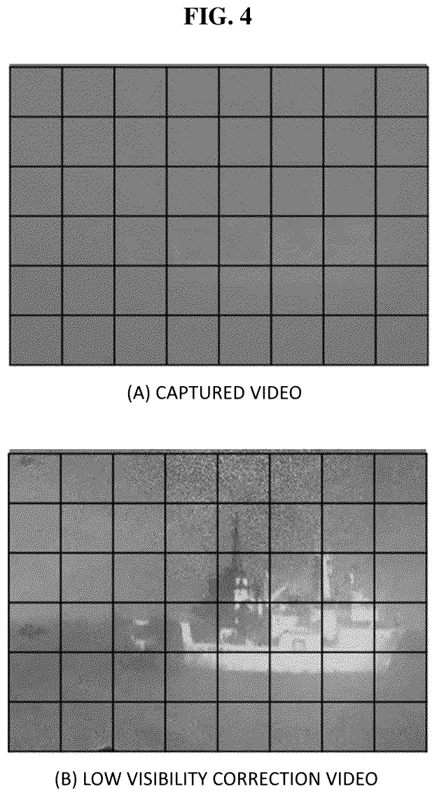

FIGS. 4A and 4B are diagrams illustrating that the video correction unit divides the captured video into block areas and then corrects the captured video.

Referring to FIGS. 4A and 4B, the video correction unit 220 may divide FIG. 4A, which is the video captured by the capturing equipment 300, into at least one block area. The video correction unit 220 may select the entire or at least one block area from divided videos and calculate the transmission rate. Thereafter, the video correction unit 220 may output the video of FIG. 4B by correcting the video of FIG. 4A.

As an example, the video correction unit 220 may divide the captured video into M×M blocks. The video correction unit 220 may calculate the transmission rate in one central block area or a selected area including one central block area and at least one diagonal block area in the divided videos. Here, M is a natural number.

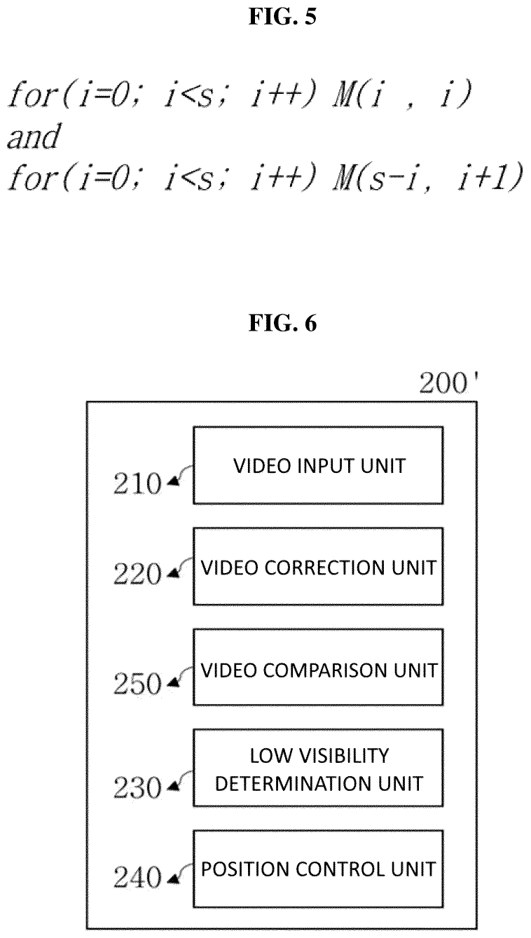

FIG. 5 is an algorithm for selecting some areas of divided videos.

Referring to FIG. 5, the video correction unit 220 may select at least one block area from the divided videos using the algorithm of FIG. 5. In FIG. 5, a parameter S that determines the number of at least one block area may be expressed as [Expression 8].

$$S \leq \sqrt{{M}^{2} + {M}^{2}} \qquad [ Expression 8 ]$$

The low visibility determination unit 230 may receive the transmission rate calculated in the selected block area from the video correction unit 220 to determine whether the mobile object 100 is positioned in the low visibility section.

In addition, it may be determined whether the left and/or right sides of the mobile object 100 are positioned in the low visibility section.

For example, the video correction unit 220 may select a left block area in the divided videos and output a left transmission rate calculated from the transmission rate to the low visibility determination unit 230. In addition, the video correction unit 220 may select a right block area in the divided videos and output a calculated right transmission rate to the low visibility determination unit 230.

When a difference between the lower limit of the left transmission rate and the lower limit of the right transmission rate is greater than a predetermined difference, the low visibility determination unit 230 may determine whether the left or right side of the mobile object 100 is positioned in the low visibility section using the lower limit of the left transmission rate and the lower limit of the right transmission rate.

For example, the lower limit of the left transmission rate may have a smaller value than the lower limit of the right transmission rate. In this case, the low visibility determination unit 230 may determine that the left side of the mobile object 100 is the low visibility section, and the right side of the mobile object 100 is not the low visibility section. In this case, the position control unit 240 may move the mobile object 100 to the left.

Conversely, the lower limit of the right transmission rate may have a smaller value than the lower limit of the left transmission rate. In this case, the low visibility determination unit 230 may determine that the right side of the mobile object 100 is the low visibility section, and the left side of the mobile object 100 is not the low visibility section. In this case, the position control unit 240 may move the mobile object 100 to the right.

FIG. 6 is a block diagram of an apparatus for controlling a position of a mobile object according to another embodiment of the present specification.

Referring to FIG. 6, an apparatus 200′ for controlling a position of a mobile object according to another embodiment of the present specification may include a video input unit 210, a video correction unit 220, a low visibility determination unit 230, a position control unit 240, and a video comparison unit 250.

Since the remaining components except for the video comparison unit 250 have been previously described, repeated descriptions thereof will be omitted.

The video comparison unit 250 may receive the captured video from the video input unit 210 and receive the corrected video from the video correction unit 220 to divide the two videos (the captured video and the corrected video) into at least one block area. Thereafter, the video comparison unit 250 may accumulate a difference in brightness of the entire or at least one block area in the two divided videos to calculate a brightness comparison value. The video comparison unit 250 may output the comparison value to the low visibility determination unit 230.

In order to calculate the comparison value, the video comparison unit 250 may convert the two videos into gray scale and compare the videos. The gray scale conversion is a technology widely known to those skilled in the art, and therefore, the detailed description thereof will be omitted.

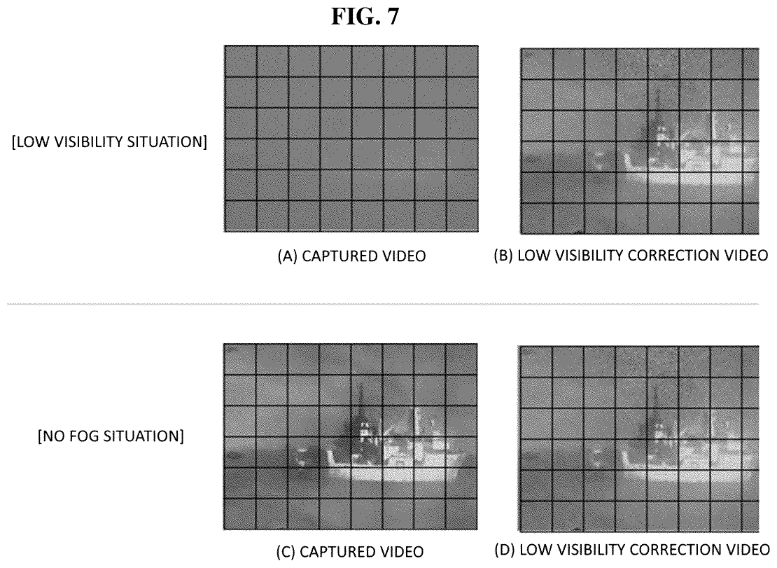

FIGS. 7A to 7D are diagrams illustrating that the video comparison unit compares the captured video and the corrected video.

Referring to FIGS. 7A to 7D, the video comparison unit 250 may divide the two videos into the block areas of M×M. Thereafter, the video comparison unit 250 may select a comparison area including the entire or at least one block area from the two divided videos. The selection of the comparison area may be performed in a manner similar to the algorithm illustrated in FIG. 5. Here, M is a natural number.

The video comparison unit 250 may calculate the difference in brightness between the two videos in the comparison area using [Expression 9].

$$Result = {\sum }_{k = 1}^{n} \vert {A}_{k} - {B}_{k} \vert \qquad [ Expression 9 ]$$

In [Expression 9], Aₖ denotes a k^{th} area or pixel of the captured video, Bₖ denotes a k^{th} area or pixel of the corrected video, and n denotes a natural number.

The low visibility determination unit 230 may determine that the mobile object 100 is present in the low visibility section when the comparison value input from the video comparison unit 250 is within the predetermined comparison value critical range.

The low visibility determination unit 230 may set the comparison value critical range to ensure that the mobile object 100 is positioned in the low visibility section. When the comparison value is out of the comparison value critical range, the low visibility determination unit 230 may determine that the mobile object 100 is out of the low visibility section.

For example, when the comparison value is greater than the upper limit of the comparison value critical range, the mobile object 100 may leave from the low visibility section in the direction away from the enemy, and thus, may monitor the enemy. Conversely, when the comparison value is smaller than the lower limit of the comparison value critical range, the mobile object 100 may leave from the low visibility section in the direction approaching the enemy, and thus, may be discovered by the enemy.

When the comparison value is greater than the upper limit of the comparison value critical range, the position control unit 240 may move the mobile object 100 forward so that the mobile object 100 is positioned in the low visibility section.

Conversely, when the comparison value is smaller than the lower limit of the comparison value critical range, the position control unit 240 may move the mobile object 100 rearward so that the mobile object 100 is positioned in the low visibility section.

The video comparison unit 250 may select the left area of the two divided videos and calculate a left comparison value that calculates the difference in brightness between the two videos. In addition, the video comparison unit 250 may select the right area of the two divided videos and calculate a right comparison value that calculates the difference in brightness between the two videos. The low visibility determination unit 230 may receive the left comparison value and the right comparison value from the video comparison unit 250. In this case, when the difference between the left comparison value and the right comparison value is greater than the predetermined difference, the low visibility determination unit 230 may determine whether the left or right side of the mobile object 100 is positioned in the low visibility section using the left comparison value and the right comparison value.

For example, when the left comparison value is greater than the right comparison value, the low visibility determination unit 230 may determine that the left side of the mobile object 100 is the low visibility section, and the right side of the mobile object 100 is not the low visibility section. In this case, the position control unit 240 may move the mobile object 100 to the left.

Conversely, when the right comparison value is greater than the left comparison value, the low visibility determination unit 230 may determine that the right side of the mobile object 100 is the low visibility section, and the left side of the mobile object 100 is not the low visibility section. In this case, the position control unit 240 may move the mobile object 100 to the right.

The video comparison unit 250 may use additional video information other than the brightness of the two videos to more accurately determine whether the mobile object 100 is present in the low visibility section.

A cycle of determining the movement direction of the mobile object 100 using the apparatuses 200 and 200′ for controlling a position of a mobile object may be determined depending on the video acquisition and video processing performance of the capturing equipment 300.

Hereinabove, it was described under the assumption that the mobile object 100 is a ship that monitors the enemy on the sea. However, the mobile object 100 may be a drone that monitors enemies in the air. As described above, the drone may determine the low visibility section in the two-dimensional directions of front/back/left/right and positioned in the low visibility section. In addition to this, of course, the drone can also determine whether the upper and/or lower portions are positioned in the low visibility section to move in a three-dimensional direction, including movement in the upward and/or downward direction. The mobile object 100 may be an aerial mobile object, a sea mobile object, an underwater mobile object, and/or a ground mobile object. In addition, the mobile object 100 may be an unmanned mobile object capable of autonomous driving, and may be a mobile object capable of not only moving by a person's manipulation, but also selectively driving autonomously. Accordingly, the mobile object 100 is not limited to the mobile objects described above.

The video input unit 210, the video correction unit 220, the low visibility determination unit 230, the position control unit 240, and the video comparison unit 250 may include a processor, an application-specific integrated circuit (ASIC), other chipsets, a logic circuit, a register, a communication modem, a data processing device, etc., known in the art to which the present invention pertains to perform calculations and various control logics. In addition, when the logics of the video input unit 210, the video correction unit 220, the low visibility determination unit 230, the position control unit 240, and the video comparison unit 250 described above is implemented by software, the video input unit 210, the video correction unit 220, the low visibility determination unit 230, the position control unit 240, and the video comparison unit 250 may be implemented as a set of program modules. In this case, the program module may be stored in the memory device and executed by the processor.

Hereinafter, a method of controlling a position of a mobile object according to the present specification will be described.

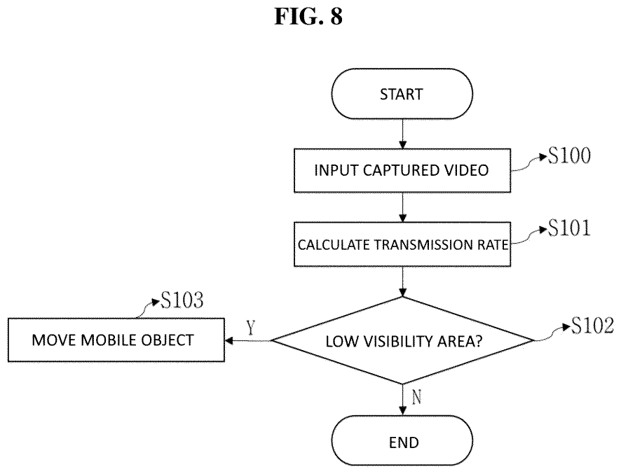

FIG. 8 is a schematic flowchart of a method of controlling a position of a mobile object according to the present specification.

Referring to FIG. 8, the processor may receive the captured video from the capturing equipment 300 in operation S100. In operation S101, the processor may calculate the transmission rate from the captured video. In operation S102, the processor may determine whether the mobile object 100 is positioned in the low visibility section using the lower limit of the transmission rate. When it is determined in operation S102 that the mobile object 100 is not positioned in the low visibility section (N in operation S102), in operation S103, the processor may move the mobile object 100 so that the mobile object 100 is positioned in the low visibility section.

The operation S101 may be an operation in which the processor may calculate the range of the transmission rate t(x) by the above [Expression 6] using the pixel value I(x) of the captured video and the atmospheric brightness A in the captured video.

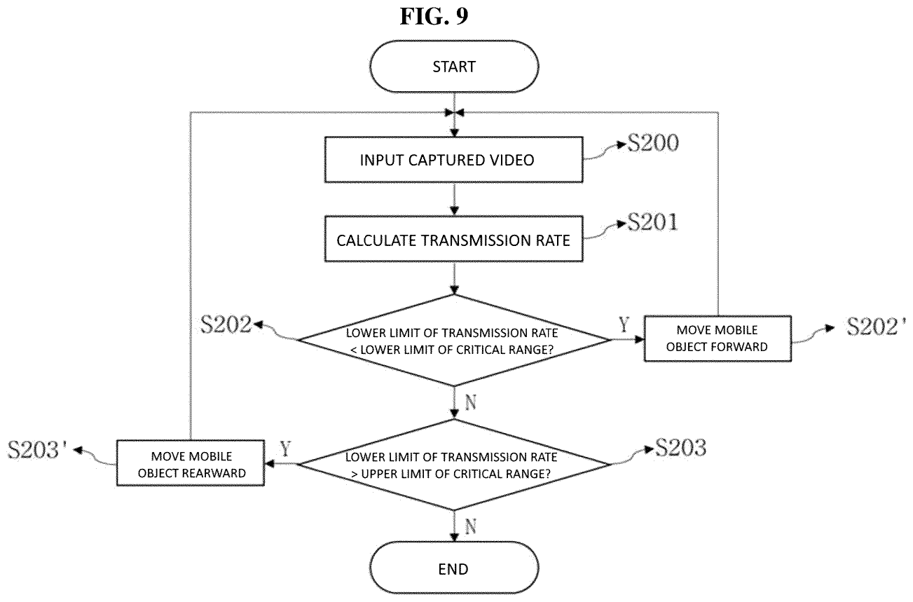

FIG. 9 is a flowchart of the method of controlling a position of a mobile object according to the embodiment of the present specification.

Referring to FIG. 9, operations S200 and S201 are the same as operations S100 and S101, and therefore, descriptions thereof will be omitted. In operation S202, the processor may compare the lower limit of the transmission rate calculated in operation S201 with the lower limit of the transmission rate critical range.

When the lower limit of the transmission rate is smaller than the lower limit of the transmission rate critical range (Y in operation S202), the processor may move the mobile object 100 forward in operation S202′.

When the lower limit of the transmission rate is not smaller than the lower limit of the transmission rate critical range (N in operation S202), the processor may compare the lower limit of the transmission rate with the upper limit of the transmission rate critical range in operation S203.

When the lower limit of the transmission rate is greater than the upper limit of the transmission rate critical range (Y in operation S203), the processor may move the mobile object 100 rearward in operation S203′.

When the lower limit of the transmission rate is not greater than the upper limit of the transmission rate critical range (N in operation S203), the processor may determine that the mobile object 100 is positioned in the low visibility section.

In FIG. 9, operation S203 is illustrated to be performed after operation S202. However, the operation S203 is not necessarily performed after the operation S202, and the operation S202 may be performed after the operation S203.

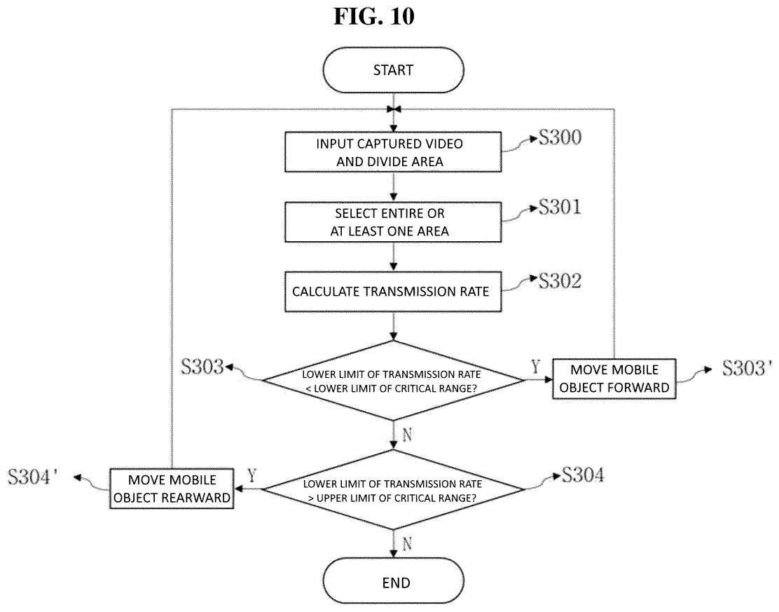

FIG. 10 is a flowchart of a method of controlling a position of a mobile object according to another embodiment of the present specification.

Referring to FIG. 10, in operation S300, the processor may receive the captured video and divide the received captured video into at least one block area. In operation S301, the processor may select the entire or at least one block area from the divided videos. In operation S302, the processor may calculate the transmission rate for the area selected in operation S301. Operations S303 and S304 are the same as the operations S202 and S203, and therefore, repeated descriptions thereof are omitted.

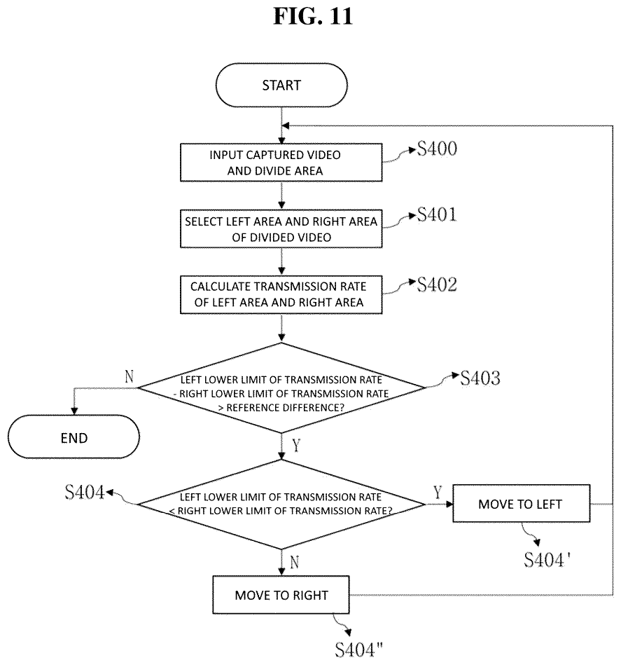

FIG. 11 is a flowchart of a method of controlling a position of a mobile object according to still another embodiment of the present specification.

Referring to FIG. 11, operation S400 is the same as operation S300, and therefore, repeated description thereof is omitted. In operation S401, the processor may select a left area and a right area from the videos divided in the operation S400, respectively. In operation S402, the processor may calculate the left and right transmission rates, respectively. In operation S403, the processor may determine whether the difference between the lower limit of the left transmission rate and the lower limit of the right transmission rate is greater than the predetermined difference.

When the difference between the lower limit of the left transmission rate and the lower limit of the right transmission rate is greater than the predetermined difference (Y in operation S403), in operation S404, the processor may compare the lower limit of the left transmission rate with the lower limit of the right transmission rate.

When the lower limit of the left transmission rate is smaller than the lower limit of the right transmission rate (Y in operation S404), the processor may move the mobile object 100 to the left in operation S404′.

When the lower limit of the left transmission rate is not smaller than the lower limit of the right transmission rate (N in operation S404), the processor may move the mobile object 100 to the right in operation S404′.

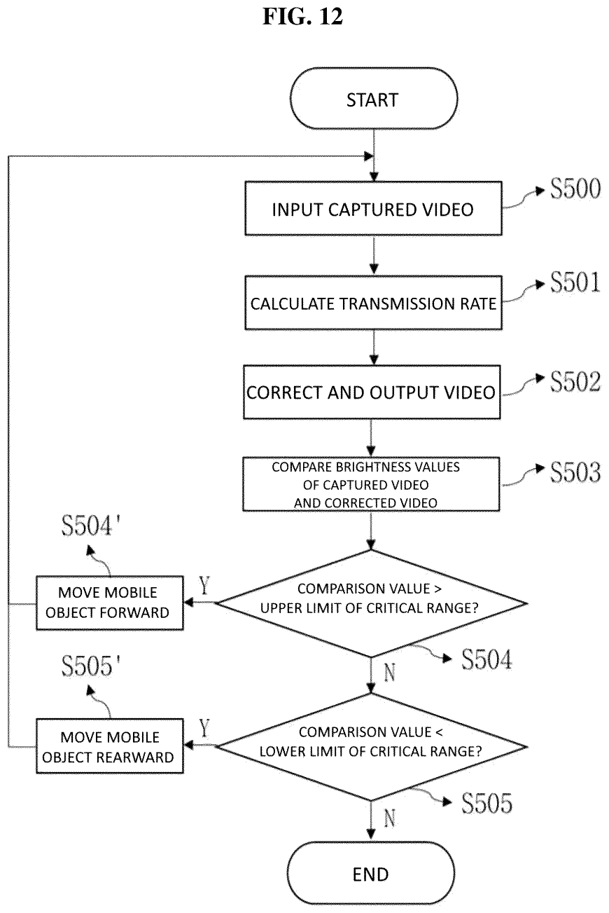

FIG. 12 is a flowchart of a method of controlling a position of a mobile object according to yet another embodiment of the present specification.

Referring to FIG. 12, the processor may compare the brightness of the captured video and the corrected video to determine whether the mobile object 100 is positioned in the low visibility section.

In operation S500, the processor may receive the captured video from the capturing equipment 300.

In operation S501, the processor may calculate the transmission rate using the above [Expression 7] in the captured video.

The processor may use the pixel value I(x) of the captured video and the atmospheric brightness A in the captured video to calculate the estimate [symbol] of the transmission rate by the above [Expression 5], and the transmission rate t(x) has the range of the above [Expression 6] and may weight sum the lower limit

$$1 - \frac{J ( x )}{A}$$

of the transmission rate t(x) and the estimate [symbol] of the transmission rate to calculate the transmission rate t(x) by the above [Expression 7].

In operation S502, the processor may correct the captured video using the transmission rate calculated using the above [Expression 7] and the above [Expression 4]. In operation S503, the processor may compare the brightness of the captured video and the corrected video. To compare the brightness, the processor may divide the captured video and the corrected video into at least one block area, select all or at least one block area of the divided block areas, and calculate the comparison value comparing the brightness. The comparison value may be calculated using the above [Expression 9].

In operation S504, the processor may compare whether the comparison value is greater than the upper limit of the comparison value critical range. When the comparison value is greater than the upper limit of the comparison value critical range (Y in operation S504), the processor may move the mobile object 100 forward in operation S504′.

When the comparison value is smaller than the upper limit of the comparison value critical range (N in operation S504), the processor may compare whether the comparison value is smaller than the lower limit of the comparison value critical range. When the comparison value is greater than the lower limit of the comparison value critical range (Y in operation S505), the processor may move the mobile object 100 rearward.

In FIG. 12, the operation S505 is illustrated to be performed after the operation S504. However, the operation S505 is not necessarily performed after the operation S504, and the operation S504 may be performed after the operation S505.

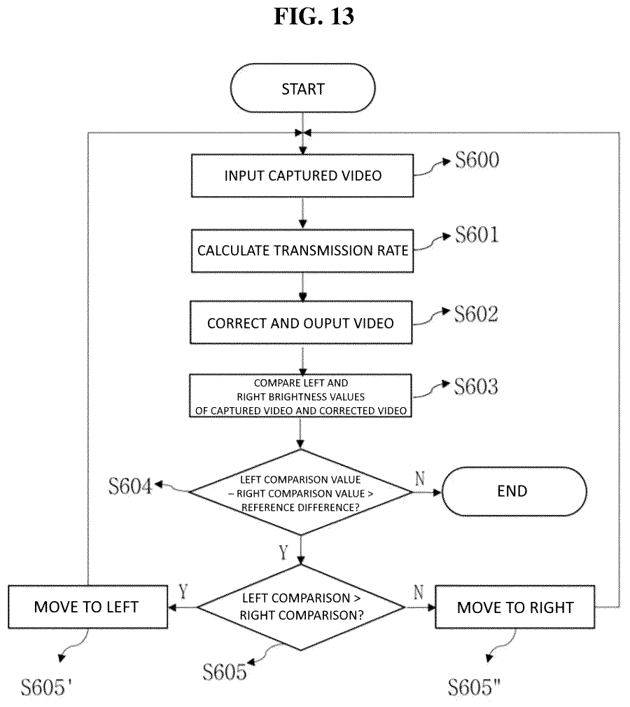

FIG. 13 is a flowchart of a method of controlling a position of a mobile object according to yet another embodiment of the present specification.

Referring to FIG. 13, operations S600 to S602 are the same as operations S500 to S502, and therefore, repeated descriptions thereof are omitted.

In operation S603, the processor may divide the captured video and the corrected video into at least one block area. Thereafter, the processor may select the left area and the right area from the divided captured videos and the corrected video, and calculate the left comparison value and the right comparison value. In operation S604, the processor may compare whether the difference between the left comparison value and the right comparison value is greater than the predetermined difference. When the difference between the left comparison value and the right comparison value is greater than the predetermined difference (Y in operation S604), the processor may compare the sizes of the left comparison value and the right comparison value in operation S605. When the left comparison value is greater than the right comparison value (Y in operation S605), the processor may move the mobile object 100 to the left in operation S605′. When the right comparison value is greater than the left comparison value (N in operation S605), the processor may move the mobile object 100 to the right.

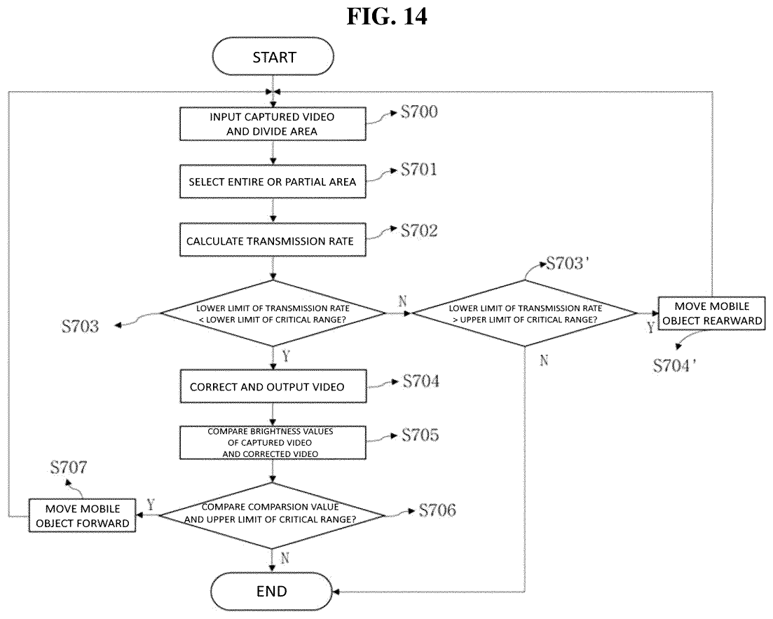

FIG. 14 is a flowchart of a method of controlling a position of a mobile object according to yet another embodiment of the present specification.

Referring to FIG. 14, in operation S700, the processor may receive the captured video and divide the received captured video into at least one block area. In operation S701, the processor may select the entire or at least one block area from the divided videos. In operation S702, the processor may calculate the transmission rate for the area selected in operation S701.

In operation S703, the processor may compare the lower limit of the transmission rate and the lower limit of the transmission rate critical range. When the lower limit of the transmission rate is smaller than the lower limit of the transmission rate critical range (Y in operation S703), the processor may correct the captured video in operation S704. In operation S705, the processor may calculate the comparison value by comparing the captured video and the corrected video. In operation S706, the processor may compare the comparison value with the upper limit of the comparison value critical range. When the comparison value is greater than the upper limit of the comparison value critical range (Y in operation S706), the processor may move the mobile object 100 forward in operation S707.

In operation S703, when the lower limit of the transmission rate is not smaller than the lower limit of the transmission rate critical range (N in operation S703), the processor may compare the sizes of the lower limit of the transmission rate and the upper limit of the transmission rate critical range in operation S703′. When the lower limit of the transmission rate is greater than the upper limit of the transmission rate critical range (Y in operation S703′), the processor may move the mobile object 100 rearward in operation S704′.

In FIG. 14, operation S703′ is illustrated to be performed after operation S703. However, operation S703′ is not necessarily performed after operation S703, and operation S703 may be performed after operation S703′.

The method of controlling a position of a mobile object according to the present specification may be implemented in the form of a computer program that is written to perform each operation on a computer and recorded on a computer-readable recording medium. In order for the computer to read the program and execute the methods implemented as the program, the computer program may include a code coded in a computer language such as C/C++, C #, JAVA, or machine language that the processor (CPU) of the computer may read through a device interface of the computer. Such code may include functional code related to a function or such defining functions necessary for executing the methods and include an execution procedure related control code necessary for the processor of the computer to execute the functions according to a predetermined procedure. In addition, the code may further include a memory reference related code for which location (address street number) in an internal or external memory of the computer the additional information or media necessary for the processor of the computer to execute the functions is to be referenced at. In addition, when the processor of the computer needs to communicate with any other computers, servers, or the like located remotely in order to execute the above functions, the code may further include a communication-related code for how to communicate with any other computers, servers, or the like using the communication module of the computer, what information or media to transmit/receive during communication, and the like.

The storage medium is not a medium that stores videos therein for a while, such as a register, a cache, a memory, or the like, but means a medium that semi-permanently stores the videos therein and is readable by an apparatus. Specifically, examples of the storage medium include, but are not limited to, a ROM, a random-access memory (RAM), a CD-ROM, a magnetic tape, a floppy disk, an optical image storage device, and the like. That is, the program may be stored in various recording media on various servers accessible by the computer or in various recording media on the computer of the user. In addition, media may be distributed in a computer system connected by a network, and a computer-readable code may be stored in a distributed manner.

According to one aspect of the present specification, an unmanned mobile object operating in a low visibility section can obtain a clear video by being positioned as close as possible to the border of the low visibility section without being detected by a monitoring device of an opposing camp.

According to another aspect of the present specification, an unmanned mobile object can avoid an opponent's neutralization response as much as possible due to features that are not identified or difficult to identify by an opponent camp, thereby providing the effect of lowering the loss of a mobile object.

The effects of the present invention are not limited to the above-described effects, and other effects that are not mentioned may be obviously understood by those skilled in the art from the following description.

Although exemplary embodiments of the present specification have been described with reference to the accompanying drawings, those skilled in the art to which the present specification belongs will appreciate that various modifications and alterations may be made without departing from the spirit or essential feature of the present invention. Therefore, it is to be understood that embodiments described above are illustrative rather than being restrictive in all aspects.

What is claimed is:

1. An apparatus for controlling a position of a mobile object, comprising:
a video input unit that receives a captured video from capturing equipment;
a video correction unit that receives the captured video from the video input unit to calculate a transmission rate, and uses the transmission rate to correct the captured video;
a low visibility determination unit that receives the transmission rate from the video correction unit, determines whether a mobile object is present in a low visibility section using a lower limit of the transmission rate, and outputs a result value; and
a position control unit that controls a position of the mobile object so that the mobile object is present in the low visibility section when a result value of determining that the mobile object is not positioned in the low visibility section is input from the low visibility determination unit.

2. The apparatus of claim 1, wherein the video correction unit calculates an estimate [symbol]
of the transmission rate by Expression
$$= 1 - \frac{α J ( x )}{A} , 0 < α < 1$$
using a pixel value I(x) of the captured video and atmospheric brightness A in the captured video,
the transmission rate t(x) has a range of
$$1 - \frac{J ( x )}{A} \leq α \leq 1 ,$$
a lower limit
$$1 - \frac{J ( x )}{A}$$
of the transmission rate t(x) and the estimate [symbol]
of the transmission rate are weight-summed to calculate the transmission rate t(x) by Expression
$$t ( x ) = + ( 1 - ω ) ( 1 - \frac{J ( x )}{A} ) , 0 < ω < 1 \text{?} ,$$
$$\text{?} \text{indicates text missing or illegible when filed}$$
and
a pixel value J(x) of the video corrected using the transmission rate t(x) calculated by the weighted sum is calculated by Expression
$$J ( x ) = \frac{I ( x ) - A}{t ( x )} + A .$$

3. The apparatus of claim 2, wherein the low visibility determination unit determines that the mobile object is positioned in the low visibility section when the lower limit of the transmission rate is present within a predetermined transmission rate critical range.

4. The apparatus of claim 1, wherein the video correction unit divides the captured video into at least one block area, selects the at least one block area from divided videos, calculates the transmission rate from the selected area, and outputs the calculated transmission rate to the low visibility determination unit.

5. The apparatus of claim 1, further comprising a video comparison unit that receives the captured video from the video input unit and receives the corrected video from the video correction unit to divide the two videos into at least one block area, selects the at least one block area from the two divided videos, and calculates a brightness comparison value, which accumulates a difference in brightness between the two videos, by Expression
$$Result = {\sum }_{k = 1}^{n} \vert {A}_{k} - {B}_{k} \vert$$
(n: natural number, Aₖ: k^{th} area or pixel of the captured video, Bₖ: k^{th} area or pixel of the corrected video), and outputs the comparison value to the low visibility determination unit.

6. The apparatus of claim 5, wherein the low visibility determination unit determines that the mobile object is present in the low visibility section when the comparison value received from the video comparison unit is present within a predetermined comparison value critical range.

7. A method of controlling a position of a mobile object, comprising:
operation (a) of receiving, by a processor, a captured video from capturing equipment;
operation (b) of calculating, by the processor, a transmission rate of the captured video;
operation (c) of determining, by the processor, whether a mobile object is present in a low visibility section using a lower limit of the transmission rate calculated in operation (b); and
operation (d) of, when it is determined that the mobile object is not positioned in the low visibility section, controlling, by the processor, a position of the mobile object so that the mobile object is present in the low visibility section.

8. The method of claim 7, wherein, in operation (b), the processor calculates a range of the transmission rate t(x) by Expression
$$1 - \frac{J ( x )}{A} \leq t ( x ) \leq 1$$
using a pixel value I(x) of the captured video and atmospheric brightness A in the captured video.

9. The method of claim 8, wherein, in operation (c), it is determined that the mobile object is positioned in the low visibility section when the lower limit of the transmission rate is present within a predetermined transmission rate critical range.

10. The method of claim 7, wherein, in operation (b), the processor divides the captured video into at least one block area, and selects the at least one block area from divided videos, and calculates the transmission rate.

11. A method of controlling a position of a mobile object, comprising:
operation (a) of receiving, by a processor, a captured video from capturing equipment;
operation (b) of calculating, by the processor, a transmission rate of the captured video;
operation (c′−1) of correcting, by the processor, the captured video using the transmission rate calculated in operation (b);
operation (c′−2) of calculating, by the processor, a comparison value of brightness between the captured video and the video corrected in operation (c′−1);
operation (c′−3) of determining, by the processor, whether a mobile object is present in a low visibility section using the comparison value calculated in operation (c′−2); and
operation (d) of, when it is determined that the mobile object is not positioned in the low visibility section, controlling, by the processor, a position of the mobile object so that the mobile object is present in the low visibility section.

12. The method of claim 11, wherein, in operation (c′−1), the processor calculates an estimate [symbol] of the transmission rate by Expression
$$= 1 - \frac{α J ( x )}{A} , 0 < α < 1$$
using a pixel value I(x) of the captured video and atmospheric brightness A in the captured video,
the transmission rate t(x) has a range of
$$1 - \frac{J ( x )}{A} \leq t ( x ) \leq 1 ,$$
a lower limit
$$1 - \frac{J ( x )}{A}$$
of the transmission rate t(x) and the estimate [symbol] of the transmission rate are weight-summed to calculate the transmission rate t(x) by Expression
$$t ( x ) = + ( 1 - ω ) ( 1 - \frac{J ( x )}{A} ) , 0 < ω < 1 \text{?} ,$$
$$\text{?} \text{indicates text missing or illegible when filed}$$
and
a pixel value J(x) of the video corrected using the transmission rate t(x) calculated by the weighted sum is calculated by Expression
$$J ( x ) = \frac{I ( x ) - A}{t ( x )} + A .$$

13. The method of claim 11, wherein, in operation (c′−2), the processor divides the captured video and the corrected video into at least one block area, selects at least one block area from the two divided videos, and calculates a brightness comparison value, which accumulates a difference in brightness between the two videos, by Expression
$$Result = {\sum }_{k = 1}^{n} \vert {A}_{k} - {B}_{k} \vert$$
(n: natural number, Aₖ: k^{th} area or pixel of the captured video, Bₖ: k^{th} area or pixel of the corrected video).

14. The method of claim 11, wherein, in operation (c′−3), the processor determines that the mobile object is present in the low visibility section when the comparison value calculated in operation (c′−2) is present within a predetermined comparison value critical range.

15. The method of claim 7, further comprising:
when it is determined in operation (c) that the mobile object moves forward,
after operation (c),
operation (c′−1) of correcting, by the processor, the captured video using the transmission rate calculated in operation (b);
operation (c′−2) of calculating, by the processor, a comparison value of brightness between the captured video and the video corrected in operation (c′−1); and
operation (c′−3) of determining, by the processor, whether the mobile object is present in a low visibility section using the comparison value calculated in operation (c′−2).

16. A computer program that is written to perform each operation of the method of controlling a position of a mobile object according to claim 7 and recorded on a computer-readable recording medium.
